(19) United States
(12) Patent Application Publication
(10) Pub. No.: US 2007/0100998 A1
(43) Pub. Date: May 3, 2007

(54) SYSTEM AND METHOD OF ACCESSING A RESOURCE ON A TRANSLATED NETWORK DEVICE

(75) Inventors: Mazin Ramadan, Seattle, WA (US); Zeyad Ramadan, Seattle, WA (US)

Correspondence Address: AXIOS LAW GROUP, 1725 WESTLAKE AVENUE NORTH, SUITE 150, SEATTLE, WA, 98109, US

(73) Assignee: PICOSTATION, INC., Seattle, WA (US)

(21) Appl. No.: 11/161,012

(22) Filed: Jul. 19, 2005

Related U.S. Application Data
(60) Provisional application No. 60/589,204, filed on Jul. 19, 2004.

(51) Int. Cl. G06F 15/173

(52) U.S. Cl. 709/225

(57) ABSTRACT

Systems and methods of obtaining resources from translated network devices are provided herein.

### FIELD

Embodiments relate to enabling access to resources on devices with translated IP addresses devices without the devices needing public IP addresses.

### BACKGROUND

Communication networks are well known in the computer communications field. By definition, a network is a group of computers and associated devices that are connected by communications facilities or links. Network communications can be of a permanent nature, such as via cables, or can be of a temporary nature, such as connections made through telephone or wireless links. Networks may vary in size, from a local area network (“LAN”), consisting of a few computers or workstations and related devices, to a wide area network (“WAN”), which interconnects computers and LANs that are geographically dispersed, to a remote access service, which interconnects remote computers via temporary communication links. An internetwork, in turn, is the joining of multiple computer networks, both similar and dissimilar, by means of gateways or routers that facilitate data transfer and conversion from various networks. A well-known abbreviation for the term internetwork is “internet.” As currently understood, the capitalized term “Internet” refers to the collection of networks and routers that use the Internet Protocol (“IP”), along with higher-level protocols, such as the Transmission Control Protocol (“TCP”) or the Uniform Datagram Packet (“UDP”) protocol, to communicate with one another.

The Internet has recently seen explosive growth by virtue of its ability to link computers located throughout the world. Other interactive environments may include proprietary environments, such as those provided by America Online, by the Microsoft Network (“MSN”) and or other online service providers, as well as the “wireless Web” provided by various wireless networking providers, especially those in the cellular phone industry. As will be appreciated from the following description, the present invention could apply in any such interactive environments; however, for purposes of discussion, the Internet is used as an exemplary interactive environment for implementing the present invention.

The Internet has quickly become a popular method of disseminating information, due in large part to its ability to deliver information in a variety of formats. To make information available over the Internet, a user typically composes a document or other data that resides on a Server connected to the Internet that has mass storage facilities for storing documents and/or data or other resources and that runs administrative software for handling requests for those stored resources. A common way of addressing a resource is through an associated Uniform Resource Locator (“URL”) that provides the location of a linked resources on a Server connected to the Internet.

At the start of the Internet, the information stored on the Internet was generally static in nature and, if one wanted to change the information contained in a document on a Server, it was necessary to manually configure the document by rewriting the document. However, at the present stage of the development of the Internet, many Servers provide dynamic content that changes depending on a user's interaction between the user's consumer device and the Server.

Accordingly, as the capabilities of the Internet have expanded, the desire for users to access resources (e.g., data, content, programs, information, capabilities, services and the like) across the Internet has increased.

The present application uses the terms “client”, “server” and “remote device” to refer to devices that communicate using the Internet or other IP networks. The Internet generally is the communication infrastructure used by applications such as the World Wide Web (“Web”), electronic mail (“e-mail”) and File Transfer Protocol (“FTP”). Examples of “clients”, “servers” and “remote devices” are systems that can communicate using the Internet. Examples may include, but are not limited to, computers, automotive systems, consumer electronic products, mobile computing device, mobile communications devices, metering equipment and other embedded/non-embedded systems that contain microcontrollers or microprocessors.

A server is a device that offers a service that is accessed by communication over a network. Servers will typically, but not always, have an always-on Internet connection as discussed in more detail below. A client is a device that accesses the services of a server by communication over a network. Any individual device may be a client for some services and a server for others. In other words, a device may be a client and a server at the same time.

Often devices may be connected to networks in a variety of fashions, including:
(1) Dial-up: where a device contains some component, such as a modem, that can, at the device's instigation, create a network connection to some another similar component on a remote device (e.g., a device owned by an Internet Service Provider [“ISP”]). This ISP owned device, such as a router, may be continuously connected a broadband network connection to carry IP packets between ISPs. The connecting device and the ISP device then run the IP protocol suite over their physical network connection. The router forwards the device's IP packets to and from the rest of the network.
(2) Always-on: this is where the connecting device always has a physical network connection to an ISP's device and the IP protocol suite is always running over this network connection.
(3) Wireless: similar to “always-on,” wireless connections operate in a similar manner, however using wireless communication protocols under the IP protocol suite.

If a particular client device is initiating the communication with a server device then it is straightforward for the client to establish an IP connection. Client initiated connection is the typical usage mode for connections.

If, however, a server wishes to initiate communication with a client then the situation is more complicated. There are problems related to Internet communication initiated by servers that apply irrespective of whether the client has an always-on or a dial-up connection to the Internet.

One problem is Network Address Translation (“NAT”). Devices connected to the Internet are identified by an IP address (or by a name corresponding to an IP address). For two devices connected the Internet to communicate they must both have separate IP addresses. IP addresses, which are supposed to be unique across the whole Internet, are called public IP addresses. Conventionally, an IP address is a thirty-two binary digit number. The use of the binary digits within IP addresses is structured to reflect network topology and real-world organizations. Consequently, not all of the possible IP addresses can be used and there are not enough public IP addresses for every device to have its own. ISPs overcome this problem using NAT. When a device creates a connection to an ISP's router, the device is allocated a private IP address by the ISP for the duration of the connection. This private IP address is supposed to uniquely identify the device within the ISP's network but not necessarily across the whole Internet (certain special ranges of IP addresses are reserved for this purpose).

When a device wishes to communicate with a device external to the ISP's own network, the ISP's router that forwards the internal device's IP packets onto the broadband network connection will replace the private source address in the IP packets with its own public IP address. The router will also remember that the internal device has sent IP packets to the external device. When the external device replies, it will send its IP packets to the ISP's router—since the IP packets it receives contain the router's public IP address as their source address. The ISP's router will realize that the IP packets are a reply to the internal device and will forward the packets to the internal device.

Devices external to the ISP cannot directly communicate with devices on the ISP's internal network because those devices on the internal network do not have public IP addresses. Devices external to the ISP can only communicate with the ISP's routers. NAT only works if a device (usually a client) internal to the ISP sends the first IP packets (for example, opening a TCP connection) of a communication so that a router can “learn” to translate between the device's private IP address and the router's public IP address.

Firewalls are the second problem related to server initiated Internet communication. A firewall is a device that restricts what IP packets are allowed to enter and leave an organization's internal TCP/IP network. Typically, a firewall will be configured to allow communication between a device in the organization's internal network and a device external to the organization's network if the internal device sends the first IP packets of the communication. This configuration is used to stop unsolicited IP packets being sent to devices within the organization. It in common to combine a firewalls and a router into a single device.

Organizations may use technology such as Virtual Private Networks (“VPNs”) to connect devices together to form a virtual TCP/IP network even if the devices are connected to different physical networks. That is, some devices in the virtual network may be attached to the same physical network; others may be connected to the virtual network via channels through the Internet, or by any other means. Devices within the virtual network may send each other IP packets without restriction. Devices external to the virtual network may not be able to send unsolicited IP packets into the virtual network because typically the VPN is connected to the broadband network through NAT or a firewall.

A new TCP/IP protocol suit, IPv6 (RFC 2460; “Internet Protocol, Version 6 (Ipv6)”; S. Deering, R. Hinden; December 1998), alleviates the shortage of IP addresses. Other new network technology, such as cable, DSL (direct subscriber line), wi-fi (IEEE 802.11), wimax (IEEE 802.16) and other wired and wireless connections allow clients to have always-on (or near always on) network connections. Despite this, many ISPs and other organizations managing Internet communication continue to use NAT or firewalls for reasons including stopping malicious external devices from sending unsolicited and unwanted IP packets to devices inside the organization. This is especially important with technologies like wireless connections where devices may have to pay for IP packets that they receive. Even in the presence of IPv6 and new network technologies that provide always-on connections, the problems of server initiated Internet communication identified above still exist.

At present, in applications where a server tries to initiate network communication with a client, the client is supposed have an always-on Internet connection and should not be subject to NAT. This will likely be expensive for the client as it will need a dedicated network connection to its ISP, dedicated capacity at its ISP and must have a scarce public IP address. For reason noted about, this situation may be undesirable. Additionally, in a cell based wireless communications system a true always-on connection may not even be possible. Further, to stop clients from receiving unsolicited IP packets, NAT or a firewall may be used even if the client does have an always-on Internet connection.

### BRIEF DESCRIPTION OF THE DRAWINGS

FIG. 1 is a pictorial diagram of a number of interconnected devices that provide network access functionality in accordance with various embodiments.

FIG. 2 is a block diagram of a client device that provides an exemplary operating environment for various embodiments.

FIG. 3 is a block diagram of a Server device that provides an exemplary operating environment for various embodiments.

FIG. 4 is a diagram illustrating the actions taken by devices in a translated network system for accessing a resource in accordance with various embodiments.

FIG. 5 is a flow diagram illustrating server interface routine in accordance with various embodiments.

FIG. 6 is a flow diagram illustrating client interface routine in accordance with various embodiments.

### DETAILED DESCRIPTION

The attached figures illustrate exemplary embodiments. Those of ordinary skill in the art will appreciate that other embodiments, including additional devices, or combinations of illustrated devices, may be added to, or combined, without changing the spirit or scope of the present invention.

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. Additionally, while the following description and accompanying drawings specifically describe the routing on a client device 200, a Server 300 and a remote device 120 using the HTTP protocol. It will be clear to one of ordinary skill in the art that the systems and methods presented herein may be extended to multiple client devices 200, multiple Servers 300 and multiple remote devices, possibly using other types of protocols.

As previously explained, the capitalized term “Internet” refers to the collection of networks and routers that use communications with one another. More specifically, the Internet includes a plurality of LANs and WANs interconnected by routers (not shown). The routers are generally special purpose computers used to interface one LAN or WAN to another. Communication links within the LANs may be formed by twisted pair wire, coaxial cable, or any other well known communication linkage technology, including wireless technology. Communication links between networks may be formed by analog telephone lines, and/or digital lines or any other well known communication linkage technology, including wireless technology. Further, computers, and other related electronic devices can be remotely connected to either the LANs or the WANs via a modem and temporary telephone link, including a wireless telephone link. It will be appreciated that the Internet comprises a vast number of such interconnected networks, computers and routers.

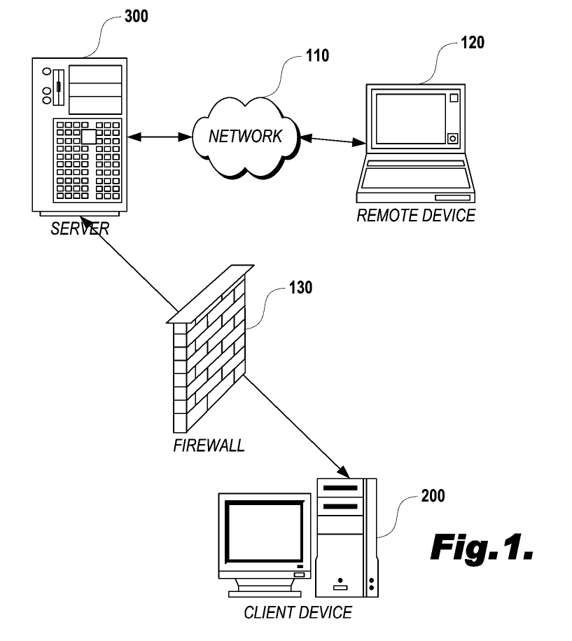

FIG. 1 illustrates an exemplary embodiment of a number of devices used in an exemplary system 100. The system 100 includes a remote device 120 in communication with a network 110, such as any of the well known data communication networks (e.g., LANs, WANs, the Internet, etc.) and connected to a Server 300 for managing communication with one or more client devices 200 behind a firewall 130 (or router). It will be appreciated by one of ordinary skill in the art that there may be a plurality of Servers 300, remote devices 120 and client devices 200, or even that the role of the Server 300 may be combined with other devices in the system 100.

In one exemplary embodiment, during an initial registration between client devices 200 to the Server 300 to establish authentication information, a unique URL is assigned to each client device 200. The URLs are addressable from the Internet and are used in resolving external Internet requests, e.g., from a Web browser. The Server 300 maintains a constantly updated “Active Client Device List” 365. The “Active Client Device List” 365 is a mapping between current open connections to client devices 200 and URLs.

Client devices 200 that initiate and maintain a connection with the Server 300 are placed in the “Active Client Device List.” Client devices 200 maintain the connection with the Server 300 by the Server 300 periodically pushing ACK (ACKnowledgement) messages to client devices 200 or a client device 200 periodically polling the Server 300 by sending ACK messages. When a client device 200 terminates the connection, the Server 300 may then remove the client device's entry in the “Active Client Device List” 365.

When a request to access a resource 260 (e.g., retrieve or store content) is initiated from a remote device 120, it arrives at the Server 300. The Server 300 may then perform:
(1) Lookup on the “Active Client Device List” 365 to find the client device connection.
(2) Forward the request to a client device 200 through the open connection.
(3) Wait for a reply message.
(4) Forward the reply message to the original request initiator at the remote device 120.

The client device 200 may then maintain an open connection with the Server 300. Upon receiving the Internet request from the Server 300 on the open connection, the client device 200 forwards the request to an appropriate service (for example, a Web service 265, or it maybe a Web Services Application or any other type of network application). In the case of where the request was to retrieve content, service returns the requested content and client device 200 forwards the content to the Server 300 in a reply message.

In another exemplary embodiment of the system 100, three computers are connected to a network 110 (e.g., the Internet) one of the computers is configured with a non-addressable/non-routable IP address (e.g., translated address, possibly using NAT) and one Server 300 configured with an addressable/routable IP address (e.g., and untranslated address). The computer in such an exemplary embodiment are configured as follows:
(1) Client device 200 (with a translated IP address) has the following running on it:
   Web Service 265 running on port configured port (e.g., port 80).
   Server Interface Software 600.
(2) Server 300 has the following:
   A public IP address (and possibly public domain name, e.g., PicoServer.com).
   Client Interface Software 500.
   Web Service 360 running on port configured port (e.g., port 80).
   A list of Active Client Devices 365.
(3) Remote device 120 has:
   Web browser software (not shown).

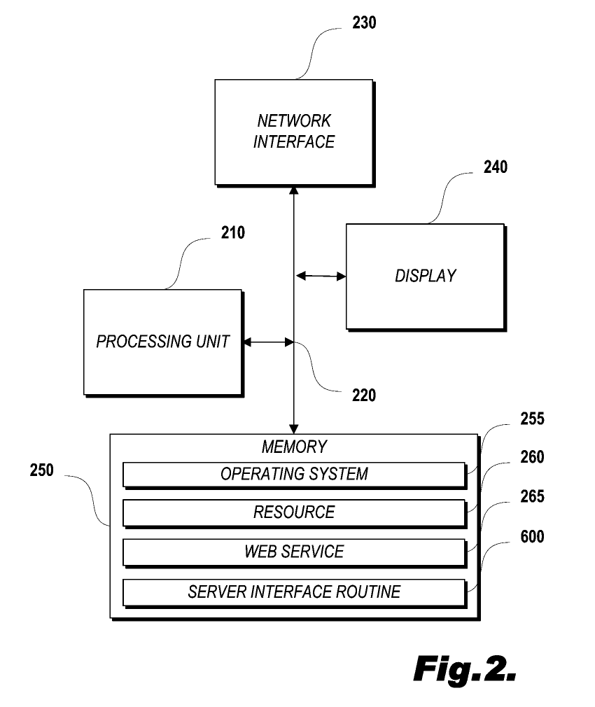

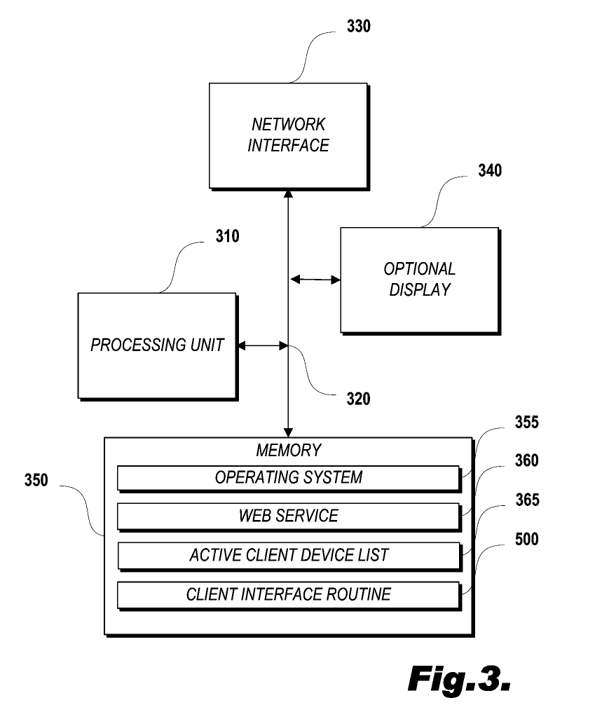

To better illustrate various embodiments, FIGS. 2 and 3 illustrate an exemplary client device 200 and Server 300, respectively.

FIG. 2 illustrates several of the components of a client device 200. Those of ordinary skill in the art will appreciate that the client device 200 may include many more components than those shown in FIG. 2. However, it is not necessary that all of these generally conventional components be shown in order to disclose an illustrative embodiment for practicing the present invention. As shown in FIG. 2, the client device 200 includes a network interface 230 for connecting to the Server 300. Those of ordinary skill in the art will appreciate that the network interface 230 includes the necessary circuitry for such a connection and is constructed for use with the appropriate protocol.

The client device 200 also includes a processing unit 210, may include an optional display 240, and a memory 250, all interconnected along with the network interface 230 via a bus 220. The memory 250 generally comprises a random access memory (“RAM”), a read only memory (“ROM”), and a permanent mass storage device, such as a disk drive. The memory 250 stores a network accessible resource 260 (e.g., data, content, programs, information, capabilities, services and the like), Web service 265, server interface routine 600 and an operating system 255. It will be appreciated that these software components may be loaded from a computer readable medium into memory 250 of the client device 200 using a drive mechanism (not shown) associated with a computer readable medium, such a floppy disk, tape or DVD/CD-ROM drive or via the network interface 230.

Although an exemplary client device 200 has been described that generally conforms to conventional general-purpose computing device, those of ordinary skill in the art will appreciate that a client device 200 may be any of a great number of devices capable of communicating with the Server 300.

FIG. 3 illustrates several of the components of a Server 300. Those of ordinary skill in the art will appreciate that the Server 300 may include many more components than those shown in FIG. 3. However, it is not necessary that all of these generally conventional components be shown in order to disclose an illustrative embodiment for practicing the present invention. As shown in FIG. 3, the Server 300 includes a network interface 330 for connecting to the Network 110. Those of ordinary skill in the art will appreciate that the network interface 330 includes the necessary circuitry for such a connection and is constructed for use with the appropriate protocol. This may be done through conventional wired or wireless systems.

The Server 300 also includes a processing unit 310, may include an optional display 340, and a memory 350, all interconnected along with the network interface 330 via a bus 320. The memory 350 generally comprises RAM, ROM and a permanent mass storage device, such as a disk drive. The memory 350 stores the program code necessary for a client interface routine 500, Web service 360, “Active Client Device List” 365 and an operating system 355. It will be appreciated that these software components may be loaded from a computer readable medium into memory 350 of the Server 300 using a drive mechanism (not shown) associated with a computer readable medium, such as a floppy disk, tape, or DVD/CD-ROM drive or via the network interface 330.

Although an exemplary Server 300 has been described that generally conforms to conventional general purpose computing device, those of ordinary skill in the art will appreciate that a Server 300 may be any of a great number of devices capable of communicating with the Network 110.

To access resources of a client device 200 in exemplary embodiments, each client device 200 should be connected with a Server 300. Either the Server 300 or the client device 200 may make the first connect request. Once contact has been established, the client device 200 may authenticate with the Server 300 to validate its identity and to notify the Server 300 its current status and whether it is available to receive resource requests.

In one embodiment, the client device 200 will communicate with the Server 300 via a TCP/IP socket connection on a pre-configured port (e.g., port 8080). Once the client is authenticated, the client device 200 will await for resource requests that may come from the Server 300. Such a request could be to view/download a certain resource 260 from the client device's memory 250, to execute instructions, or even to store data on the client device 200.

The client device 200 may be responsible to keep the connection with the Server 300 alive, e.g., by the client device 200 sending an ACK message periodically to prevent timeouts. In the case of a lost connection the client device 200 and the Server 300, the client device 200 will detect a connection lost event and would attempt to establish connection again and reauthenticate with the Server 300.

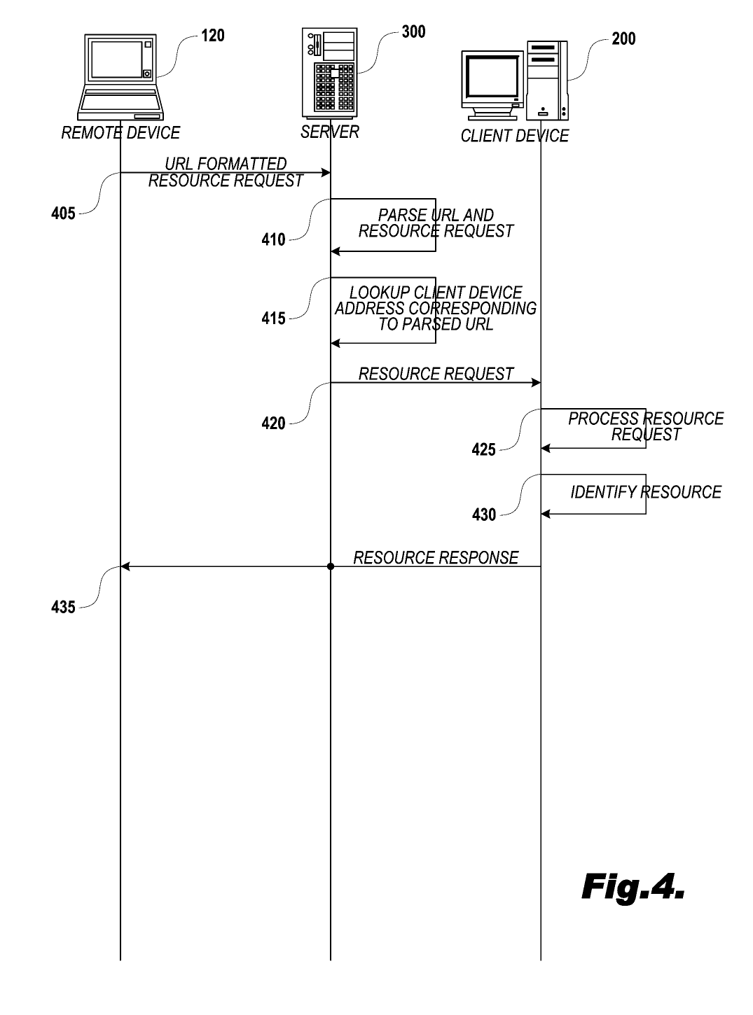

FIG. 4 illustrates steps taken to access a resource on a client device 200 according to one exemplary embodiment. FIG. 4 illustrates a remote device 120, Server 300 and client device 200 in communication with each other. The resource access process is initiated when a remote device 120 requests a resource from a client device 200 specified in a URL that routes to Server 300. The Server 300 parses 410 the URL formatted resource request and looks up 415 a client device 200 in an active client devices list 365 (whose identifier was parsed out of the request). The Server 300 sends 420 the resource request to the identified client device 200. At the client device 200, the resource request is processed 425 and the desired resource is identified 430. The identified resource 260 is returned 435 in a resource response to the remote device 120 (via the Server 300).

In one embodiment, Server 300 has a public domain name (e.g., “picoserver.com”) and the client interface software 500 installed on it. The Server 300 maintains a mapping list named “Active Client Device List” 365 if a client device 200 named “client-a” initiates a connection on port 8080 the Server 300 will place the connection information mapped to “client-a” on in the “Active Client Device List.” If the connection closes with “client-a” the Server 300 will remove the entry from the “Active Client Device List” 365. The Server 300 is in a state of listening on both port 80 and port 8080 for connections. In addition, the Server 300 ignores any ACK messages sent from the client device 200.

In exemplary embodiments, if an HTTP GET message that starts with URL of value “HTTP://picoserver.com/client-a/anypage.html” is requested from a connection on port 80, Server 300 will parse the request looking for the word between the first and the second single slash in this case the word is “client-a”. The Server 300 will look to in the “Active Client Device List” 365 for a connection mapped to “client-a”. If such connection exists, the Server 300 will route the HTTP request message received on port 80 to the “client-a” connection on port 8080 and wait for a response.

In alternate embodiments, the Server 300, may maintain another list, the “Active User List” (not shown), of all user names that have established a connection to the Server 300 and been authenticated. As an example, if user with username “Mazin” has been connected and authenticated, the Server 300 will maintain this information in the “Active User List” with the IP address of the client device 200 from which “Mazin” is connecting. The Server 300 will be listening on Port 80 to serve any request that is coming from a remote device 120, and on port 8080 to communicate with the client device 200.

If in one example, remote device 120 sends an HTTP request (e.g., a “GET” request) to a URL (e.g., “HTTP://picoserver.com/user/Mazin/somePage.html”) the Web browser will send the HTTP request to the Server 300 on port 80. The Server 300 will intercept the request and parse the URL in order to decide if this request needs to be routed to a client device 200 or if this request should to be served from the Server 300 itself. In this example, the Server 300 will recognize that this request needs to be routed to a client device 200 having a user with a username “Mazin.” The Server 300 will check the “Active User List.” If the user “Mazin” (and of course his client device 200) is online, the Server 300 may send the request to “Mazin's” client device 200 on port 8080 and wait for the reply. The client deice 200 will receive the request on port 8080, and may launch a different task (or thread) to process the request. The client device 200 may also identify the resource 260 that is being requested for and try to stream that resource on the same socket connection that is been established already between the Server 300 and the client device 200. Once the Server 300 gets the reply, the Server 300 in turn will forward the response back on port 80 back to the remote device 120. The remote device 120 receives the “somePage.html” and renders the resource on the Web browser.

If “Mazin” or his client device 200 is not online, the Server 300 may return an HTML error page “NOT FOUND.”

Expressed another way: in one specific embodiment, the client device 200 operates in the following fashion: it opens a TCP/IP socket connection to Server 300 port 8080 and keeps the connection alive by periodically polling the Server 300 by sending ACK messages. In one example, when an HTTP request arrives, client device 200 will replace the first part of the URL, e.g., HTTP://picoserver.com/user/ with HTTP://localdevice/user/ and append it to the rest of remaining part of the URL and sends the request to local port 80 when the Web server software 265 is running and route any reply to the already established connection with port 8080 on the Server 300.

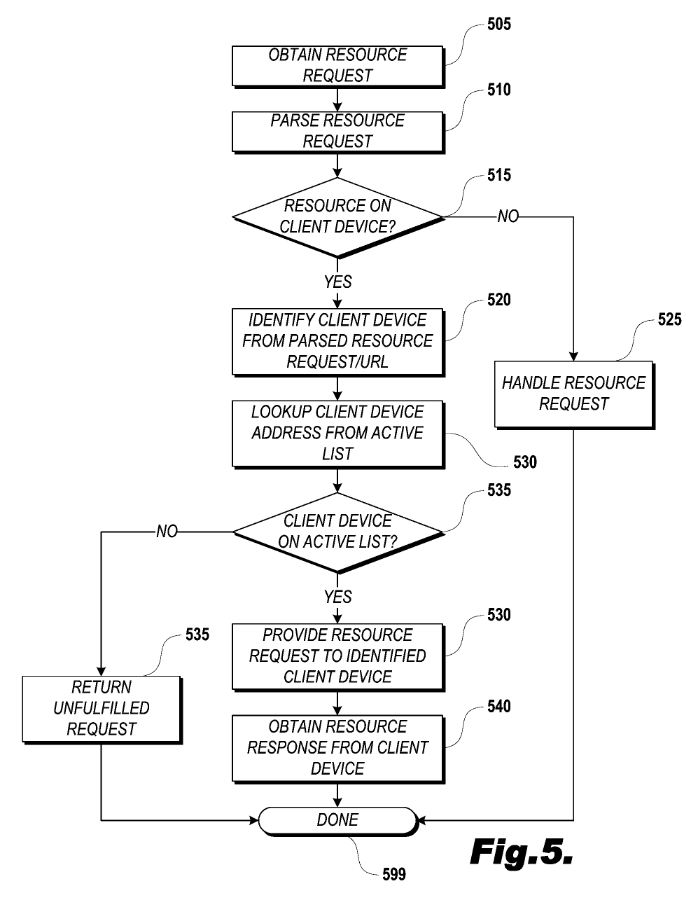

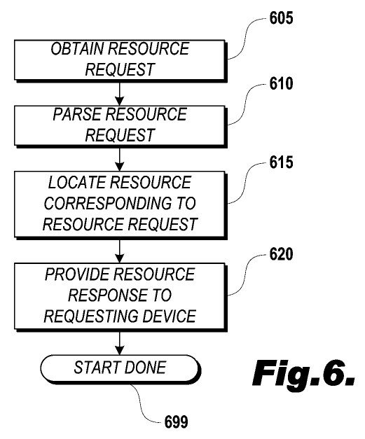

To better illustrate exemplary embodiments, FIGS. 5 and 6 illustrate the client interface routine 500 of the Server 300 and server interface routine 600 of the client, respectively.

FIG. 5 illustrates the client interface routine 500 from the point of view of the Server 300. Client interface routine 500 starts at block 505, where a resource request is obtained (e.g., as a URL). In block 510, the resource request is parsed to examine its components. In decision block 515, a determination is made whether the requested resource is on a client device 200 or on the Server 300. If it was determined, in decision block 515, that the desired resource is on the Server 300, processing proceeds to block 525. In block 525, the Server 300 handles the resource request. Next, processing proceeds to block 599, where client interface routine 500 ends.

If, however, in decision block 515, it was determined that the resource is on a client device 200, processing proceeds to block 520 where the client device 200 that the resource resides on is identified from the parsed resource request (URL). In block 530, the client device's address is looked up from an “Active Client Device List” 365 to determine where the resource request should be next directed.

In decision block 535, a determination is made whether the requested client device 200 is on the “Active Client Device List” 365. If the “Active Client Device List” 365 does not show the requested client device 200, then in block 535 an indication that the request is unfulfilled it is returned (e.g., via and unavailable Web page message) and processing proceeds to block 599 where client interface routine 500 ends.

If, however, in decision block 535 it was determined that the client device 200 is on the “Active Client Device List” 365, processing proceeds to block 530 where the resource request is provided to the identified client device 200. In block 540, a resource response is obtained from the client device 200 and client interface routine 500 ends at block 599.

FIG. 6 illustrates the resource access process from the point of view of the client device 200 as server interface routine 600. Server interface routine 600 starts at block 605 where a resource request is obtained. The resource request is parsed in block 610. In block 615, the resource requested in the resource request is located on the client device 200. Next, in block 620, the resource is provided in a resource response to the requesting device (e.g., Server 300 and remote device 120). Server interface routine 600 ends at block 699.

To illustrate one embodiment exemplary embodiment, assume the initial conditions:
(1) client device 200 has established a connection with Server 300 on 8080 under the ID “client-a” and maintaining the connection by polling the Server 300.
(2) Server 300 has placed “client-a” connection information in the “Active Client Device List” 365 and is in the listening state.

Remote device 120 through the Web browser sends an HTTP GET request with the URL “HTTP://picoserver.com/client-a/page1.html”. The Web browser will send an HTTP get request for “HTTP://picoserver.com/client-a/page1.html” to the Server 300 on port 80. The Server 300 will parse the request looking for the word between the first and second single slash “client-a”, and will lookup “client-a” in the “Active Client Device List” 365 and retrieve the currently established connection on port 8080. The Server 300 will then forward the HTTP request to client device 200 on the 8080 connection and wait for a reply.

The Client device 200 will receive the HTTP GET message and parse it to replace “HTTP://picoserver.com/client/” with “HTTP://localdevice/page1.html”. The client device 200 then forwards the new URL to the Web service 265 and as soon as response is returned for the Web service 265, the client device 200 will forward the response to the Server 300 through the already established connection on port 8080.

The Server 300 will in turn forward the response message as reply to the original HTTP GET request from the browser on port 80. The remote device 120 receives the resource “page1.html” and renders it on a Web browser.

Although various embodiments have been specifically illustrated and described herein, it will be appreciated that modifications and variations of the present invention are covered by the above teaching and within the purview of the appended claim without departing from the spirit and intended scope of the inventions. For example, although the various embodiments have been described as routing to a computer, other devices can be routed to the Internet, such as mobile phones, set top boxes and the like. Alternately, other protocols (e.g., a streaming music, video or other protocol) may be used as instead of the HTTP protocol.

What is claimed is:

1. A method of obtaining a resource from a translated network device, the method comprising:
Obtaining an initial resource request from a remote device;
Processing said initial resource request to determine a destination translated network device; and
Communicating a representation of said initial resource request to said destination translated network device.

2. The method of claim 1 wherein said initial resource request includes a uniform resource locater.

3. The method of claim 2, further comprising processing said initial resource request with a Web service.

4. The method of claim 1 further comprising returning the resource to said remote device.

5. The method of claim 1 wherein processing comprises comparing at least a portion of said initial resource request with a list of at least one translated network devices.

6. A method of claim 5 wherein said list of at least one translated network devices indicates at least one destination translated network device.

7. The method of claim 1 wherein communicating a representation comprises sending data representing a resource request to a translated network address of the destination translated network device.

8. A computer readable medium comprising computer executable instructions for performing the method of any of claims 1-7.

9. An apparatus comprising a processor and a memory containing computer executable instructions, which when executed by the processor operate to perform the method of any of claims 1-7.

10. A system comprising:
a client device;
a remote device; and
a Server operative to:
Obtain an initial resource request from said remote device;
Process said initial resource request to determine that said client device is a destination client device; and
Communicate a representation of said initial resource request to said client device.

11. A system for obtaining a resource from a translated network device, comprising:
Means for obtaining an initial resource request from a remote source;
Means for processing said initial resource request to determine a destination translated network device; and
Means for communicating a representation of said initial resource request to said destination translated network device.
